(19) United States
(12) Patent Application Publication
(10) Pub. No.: US 2016/0122856 A1
(43) Pub. Date: May 5, 2016

(54) METHOD FOR COATING A PARTIAL AREA OF A WORKPIECE AND SCREENING ELEMENT

(71) Applicant: OERLIKON METCO AG, WOHLEN, Wohlen (CH)

(72) Inventors: Juerg WIPF, Neftenbach (CH); Marco PAOLOZZI, Bremgarten (CH)

(73) Assignee: OERLIKON METCO AG, WOHLEN, Wohlen (CH)

(21) Appl. No.: 14/896,128

(22) PCT Filed: May 21, 2014
(86) PCT No.: PCT/EP2014/060386

§ 371 Date: Dec. 4, 2015

(30) Foreign Application Priority Data
Jun. 6, 2013 (EP) 13170729.1

(51) Int. Cl. C23C 4/12; H01F 7/20

(52) U.S. Cl. CPC C23C 4/12; H01F 7/20

(57) ABSTRACT

To allow a simple and thus inexpensive coating of a part surface of a workpiece, it is proposed in accordance with the invention that the screening element (15, 19) is magnetic at least during an application of a magnetizable coating material. The screening element (15, 19) is demagnetized for removing the accumulated coating material. The coating material accumulated on the screening element (15, 19) can thus be removed very easily and fast and thus inexpensively.

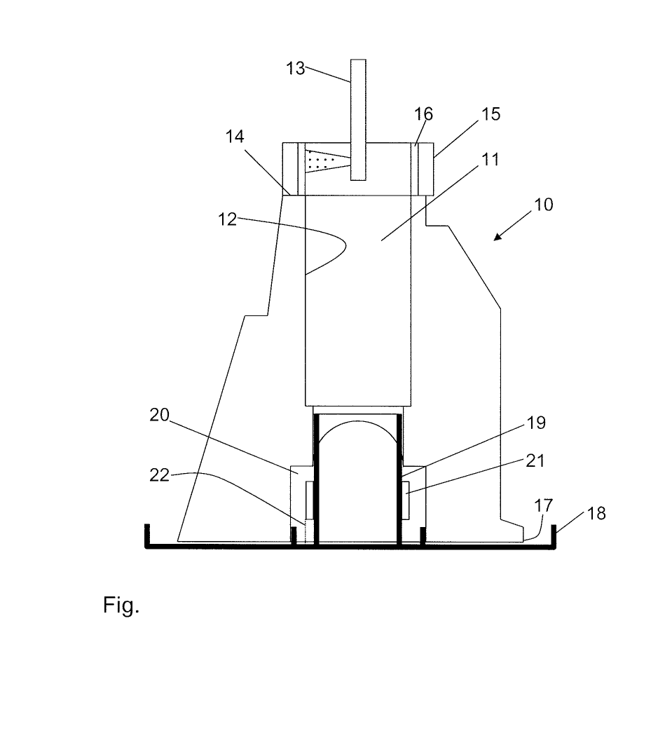

The invention relates to a method of coating a part surface of a workpiece having the features of claim 1 and to a screening element in accordance with the preamble of claim 10.

A method of coating a part surface of a workpiece with a coating material is described in EP 1 258 540 A1, wherein the workpiece is designed as a crankcase or as an engine block for a combustion engine and the named part surface is designed as an inner cylinder surface of a cylinder of the crankcase. To delineate the inner cylinder surface and thus to prevent a contamination of the crankcase and of the environment, a screening element in the form of a hollow cylindrical mask is placed onto the cylinder. The screening element is in this respect either designed such that at least some of the coating material adhering to it can be mechanically removed or such that it has a removable and thus replaceable insert.

A method of coating in the form of lacquering a part surface of a workpiece with a coating material in the form of lacquer is described in DE 103 21 700 A1. The workpiece in this case is represented by body parts of a motor vehicle made from sheet steel or sheet iron. To delineate the part surface to be lacquered or to cover parts not to be lacquered, a screening element is proposed in the form of a masking means which is magnetic at least in part. The screening element is held at the workpiece via magnetic force during the application of the coating material. As soon as too much coating material adheres to the screening element, it is partly or fully removed.

In view of this, it is in particular the object of the invention to propose a method and a screening element which allow a simple and thus inexpensive coating of a part surface of a workpiece. This object is satisfied in accordance with the invention by a method having the features of claim 1 and by a screening element having the features of claim 10.

In accordance with the invention, on the coating of a part surface of a workpiece with a magnetizable coating material, a screening element is arranged at the workpiece which is magnetic at least during an application of the coating material in order to delineate the named part surface, wherein coating material also accumulates on the screening element on the application of the coating material. After a single or multiple use of the screening element, the screening element is demagnetized for the removal of accumulated coating material. The accumulated coating material is in this respect predominantly or only held on the screening element due to a magnetic attraction between the screening element and the coating material. The coating material accumulated on the screening element falls off the screening element on its own due to the named demagnetization. If necessary, the removal of the coating material can be assisted by simple shaking of the screening element and/or by wiping off. The coating material accumulated on the screening element can thus be removed very easily and fast and thus inexpensively. In addition, no wear occurs over the whole screening element so that it can be reused frequently. A complex and/or expensive mechanical removal or the frequent replacement of parts of the screening element or of the entire screening element is not necessary. Since the removal of the coating material is very simple, it can be carried out very frequently, for example after every coating of the part surface. It is thus ensured that the screening element always has exactly the desired shape and its shape does not vary over time due to a number of layers of the coating material lying over one another. A very exact and reproducible delineation of the part surface is thus always ensured so that it is ensured that it is always exactly the desired part surface which is coated.

The coating material can, for example, be a powder on a ferromagnetic basis, for example an iron basis, such as is described in the applicant's EP 1 174 524 A2. It can be a mixture of iron (Fe), chromium (Cr), manganese (Mn), sulfur (S) and carbon (C).

The coating material can have the following composition, for example:
Fe=difference to 100% by weight
Cr=0.1 to 18.0% by weight
Mn=0.1 to 6.0% by weight
S=0.01 to 0.5% by weight
C=0.1 to 1.2% by weight.
   However, other suitable magnetizable coating materials can also be used.

A “delineation” of the part surface by the screening element is to be understood in this connection such that the screening element is arranged such that the coating material is only applied to the named part surface and not additionally to unwanted surfaces or to the environment of the workpiece.

The removal of the coating material from the screening element can take place in an automated manner or by hand. It can in particular take place in a special demagnetizing station in which the removed coating material can be led off, that is sucked off, for example.

In an embodiment of the invention, the screening element has a non-stick coating which prevents an adhesion of the coating material to the screening element or at least makes it more difficult. An “adhesion” is to be understood in this connection as the build-up of a connection between the coating material and the screening element which holds the coating material on the screening element in addition to the above-described magnetic attraction. The coating material can thus be removed from the screening element particularly easily during or after the demagnetization. The non-stick coating is, for example, up to a maximum of 2 mm thick.

The non-stick coating is in particular designed as a ceramic coating. A non-stick coating is particularly advantageous which is manufactured from zirconium oxide stabilized by magnesium oxide. For this purpose, a coating material can, for example, be used which is marketed by the applicant under the sales name Merco 210 and which has the composition ZrO₂24MgO. The non-stick coating can thus, on the one hand, be applied simply and inexpensively by means of a thermal spray process, for example by means of a plasma spray process and, on the other hand, such a non-stick coating particularly effectively prevents the adhesion of coating material on the screening element.

In an aspect of the invention, the workpiece is designed as a crankcase for a combustion engine and the part surface is designed as an inner cylinder wall of a cylinder of the crankcase. The crankcase in particular comprises an aluminum alloy or a magnesium alloy or cast iron and the coating of the inner cylinder wall is in this respect applied in order to achieve a coefficient of friction which is as small as possible between a piston and the cylinder, said piston moving to and fro in the cylinder in the operation of the combustion engine. Such coatings are in part manufactured in mass production in large volumes so that particularly high cost savings are thus made possible by the method in accordance with the invention.

In an aspect of the invention, the application of the coating material takes place by means of a thermal spray process, that is, for example, by means of a plasma spray process, which is carried out at atmospheric pressure, for example. Such plasma spray processes are termed so-called APS processes. Other coating processes by means of which a magnetizable coating material can be applied can, however, also be used. In this respect, it can, for example, be a plasma spray process which is carried out at a reduced pressure, which is termed a so-called LPPS process. Furthermore, further processes such as flame spraying, high velocity flame spraying, arc spraying or cold gas spraying are possible.

In an aspect of the invention, the screening element is designed as an electromagnet which is activated at least during the application of the coating material. “Activated” is to be understood in this connection such that the electromagnet is supplied by an electrical energy source such that it can exert a magnetic attraction on the coating material. In the design of the screening element as an electromagnet, the demagnetization can advantageously be carried out particularly simply in that the supply with electrical energy is interrupted and thus the electromagnet is deactivated. In addition, in this case, the electromagnet can particularly simply only be activated when a magnetic attraction of the screening element is also desired, that is, for example, only during the application of the coating material.

In an aspect of the invention, the screening element is designed as a permanent magnet which is magnetized again after the demagnetization for removing the accumulated coating material and can thus be used again in a coating process in accordance with the invention. No electrical connection to the screening element is thus necessary during the coating, which can be advantageous in dependence on the deployment site of the screening element.

The permanent magnet is in particular produced from a ferromagnetic material, for example iron or, if a stronger permanent magnet is required, from samarium cobalt (SmCo₅) or neodymium iron boron (Nd₂Fe₁₄B). In this respect, the screening element can completely, or at least partly, comprise the named material.

The demagnetization takes place in this case in that the screening element is exposed to a strong alternating magnetic field which then gradually decays. This magnetic field has to be so strong that the so-called coercive field strength of the material of the permanent magnet is reached. A reversal of the magnetism of the permanent magnetic material takes place by the alternating field as the amplitude reduces.

The subsequent magnetization of the screening element takes place in that it is exposed to a strong permanent magnetic field.

In an aspect of the invention, the screening element is designed as a part of a receiving apparatus for the workpiece. In industrial production, workpieces are usually arranged in receiving apparatus in order thus to ensure a simple handling and/or an exact positioning of the workpiece during the processing, for example during the coating. No separate workstep for the arrangement of the screening element at the workpiece is required due to the design of the screening element as a part of such a receiving apparatus. An otherwise necessary workstep can thus be dispensed with, which allows a simple and thus inexpensive running of the coating process. The design of the screening element as a part of such a receiving apparatus is in particular sensibly possible when the removal of the coating material from the screening element is possible without dismantling the screening element, that is, for example, on the design of the screening element as an electromagnet.

The above-named object of the invention is also achieved by a screening element for delineating a part surface of a workpiece to be coated with a magnetizable coating material, with said screening element being designed as an electromagnet.

The screening element in particular has a non-stick coating which at least makes an adhesion of the coating material to the screening element more difficult. The non-stick coating is in particular manufactured from zirconium oxide stabilized by magnesium oxide.

The screening element is in this respect in particular designed as a part of a receiving apparatus for the workpiece.

Further advantages, features and details of the invention result with reference to the following description of embodiments and to the drawing.

The only FIGURE shows a schematic diagram of a crankcase for a combustion engine having two screening elements during a coating process of an inner cylinder surface.

In accordance with the only FIGURE, a crankcase 10 for a combustion engine has a cylinder 11. The crankcase 10 has a total of four cylinders of which only the cylinder 11 can be seen in the sectional representation of the only FIGURE. A layer of a magnetizable coating material should be applied to an inner cylinder wall 12 of the cylinder 11. The crankcase 10 can thus be considered as a workpiece and the inner cylinder wall 12 as a part surface of the workpiece.

The coating material is applied by means of a rotating plasma torch 13. The plasma torch 13 can be moved in an axial direction of the cylinder 11 by means of a positioning device, not shown, and thus the entire inner cylinder surface 12 can be coated.

To prevent an application of coating material to an upper side 14 of the crankcase 10, a first screening element 15 is arranged flush with the cylinder 11 at the surface 14. The first screening element 15 is hollow cylindrical and has at its inner surface a ceramic non-stick coating 16 which is manufactured from zirconium oxide stabilized with magnesium oxide. The non-stick coating 16 is shown in very exaggerated form in the FIGURE. An inner diameter of the first screening element 15, including the non-stick coating 16, in this respect corresponds to an inner diameter of the cylinder 11.

The first screening element 15 is designed as a permanent magnet and thus attracts the magnetizable coating material and holds it firmly. Coating material is thus also accumulated on the screening element 15 on the application of the coating material. Furthermore due to the non-stock coating 16, no connection arises between the coating material and the first screening element 15 so that the coating material is only held at the screening element 15 by the magnetic attraction.

After a single or multiple use of the first screening element 15, it is demagnetized in a demagnetization station, not shown, so that the accumulated coating material drops off and can be disposed of or reused. After the demagnetization, the first screening element 15 is magnetized again and is thus made suitable for use again.

The crankcase 10 is arranged at a lower side 17 in a receiving apparatus 18 which ensures an exact positioning of the crankcase 10 with respect to the plasma torch 13. The receiving apparatus 18 has a second screening element 19 which protects an inner crankcase space 20 from the unwanted application of coating material and thus delineates the part surface to be coated in the direction of the lower side 17 of the crankcase 10. The second screening element 19 likewise has a basic shape of hollow cylindrical shape and is designed as an electromagnet. For this purpose, it has a coil 21 which is arranged at its outer side and which can be supplied with electrical energy via electrical lines 22 from an electrical energy supply not shown in any further detail. At its inner side, it has, like the first screening element 15, a ceramic non-stick coating, not shown.

The coil 21 is then supplied with electrical energy and thus the second screening apparatus 19 designed as an electromagnet is activated when the coating material is applied by means of the plasma torch 13. Once the application has ended, the supply with electrical energy is interrupted so that the second screening apparatus 19 is demagnetized. As a consequence of this, the coating material accumulated at the second screening element 19 falls of and can be disposed of or reused.

1. A method of coating a part surface (12) of a workpiece (10) with a magnetizable coating material, wherein
a screening element (15, 19) which is magnetic at least during an application of the coating material is arranged at the workpiece (10) to delineate the named part surface (12); and
the screening element (15, 19) is demagnetized to remove accumulated coating material.

2. A method in accordance with claim 1,
characterized in that
the screening element (15, 19) has a non-stick coating (16) which at least makes an adhesion of the coating material to the screening element (15, 19) more difficult.

3. A method in accordance with claim 2,
characterized in that
the non-stick coating (16) is designed as a ceramic coating.

4. A method in accordance with claim 3,
characterized in that
the non-stick coating (16) is manufactured from zirconium oxide stabilized by magnesium oxide.

5. A method in accordance with claim 1,
characterized in that
the workpiece (10) is designed as a crankcase for a combustion engine and the part surface (12) is designed as an inner cylinder wall of a cylinder (11) of the crankcase (10).

6. A method in accordance with claim 1,
characterized in that
the application of the coating material takes place by means of a thermal spray process.

7. A method in accordance with claim 1,
characterized in that
the screening element (19) is designed as an electromagnet which is activated at least during the application of the coating material.

8. A method in accordance with claim 1,
characterized in that
the screening element (15) is designed as a permanent magnet which is magnetized again after the demagnetization.

9. A method in accordance with claim 1,
characterized in that
the screening element (19) is designed as a part of a receiving apparatus (18) for the workpiece (10).

10. A screening element for delineating a part surface (12) of a workpiece (10), said part surface to be coated with a magnetizable coating material,
characterized in that
the screening element (19) is designed as an electromagnet.

11. A screening element in accordance with claim 10,
characterized by
a non-stick coating which at least makes an adhesion of the coating material to the screening element (19) more difficult.

12. A screening element in accordance with claim 11,
characterized in that
the non-stick coating is designed as a ceramic coating.

13. A screening element in accordance with claim 12,
characterized in that
the non-stick coating is manufactured from zirconium oxide stabilized by magnesium oxide.

14. A screening element in accordance with claim 10,
characterized in that
the screening element (19) is designed as a part of a receiving apparatus (18) for the workpiece (10).
